(19) United States
(12) Patent Application Publication
(10) Pub. No.: US 2026/0340778 A1
(43) Pub. Date: Oct. 29, 2026

(54) IMAGE INPAINTING MACHINE LEARNING SYSTEM TRAINING DISTILLATION

(71) Applicant: QUALCOMM Incorporated, San Diego, CA (US)

(72) Inventors: Shreya KADAMBI, San Diego, CA (US); Shubhankar Mangesh BORSE, San Diego, CA (US); Munawar HAYAT, San Diego, CA (US); Fatih Murat PORIKLI, San Diego, CA (US)

(21) Appl. No.: 19/187,658

(22) Filed: Apr. 23, 2025

(51) Int. Cl. G06T 5/60; G06T 5/77

(52) U.S. Cl. CPC G06T 5/60; G06T 5/77; G06T 2207/20081; G06T 2207/20084

(57) ABSTRACT

Systems and techniques are described herein for machine learning system training distillation. For example, a computing device can process, using a first machine learning system, training data to determine a first plurality of outputs, each output of the first plurality of outputs corresponding to a layer of the first machine learning system; determine, based on a comparison of the first plurality of outputs to a second plurality of outputs associated with a second machine learning system, a layer-by-layer loss associated with the first machine learning system; and adjust parameters of one or more layers of the first machine learning system based on the layer-by-layer loss.

### FIELD

The present disclosure generally relates to training machine learning systems using training distillation. For example, aspects of the present disclosure relate to systems and techniques for image inpainting machine learning system training distillation.

### BACKGROUND

Various image processing techniques can be used by machine learning systems (e.g., machine learning models) to perform inpainting, such as interpolation and diffusion models. Image inpainting can include editing a region of an image, such as adding objects to an image, filling in a missing area of an image, or repairing damaged regions of an image. Machine learning system architectures, such as neural networks can be used to learn contextual features of images to predict objects or edits to images which should be performed during inpainting. Other machine learning model architectures, such as Generative Adversarial Networks (GANs) can be used to generate edits to the image which can be applied to an image to perform inpainting. Traditional inpainting techniques however can be resource intensive. The resource intensive nature of traditional machine learning systems for inpainting make traditional machine learning systems difficult to execute on electronic devices where computing resources can be limited, such as a smartphone, tablet, laptop, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for machine learning system training distillation is provided. The apparatus includes at least one memory and at least one processor coupled to the at least one memory and configured to: process, using a first machine learning system, training data to determine a first plurality of outputs, each output of the first plurality of outputs corresponding to a layer of the first machine learning system; determine, based on a comparison of the first plurality of outputs to a second plurality of outputs associated with a second machine learning system, a layer-by-layer loss associated with the first machine learning system; and adjust parameters of one or more layers of the first machine learning system based on the layer-by-layer loss.

In some aspects, a method for machine learning system training distillation is provided. The method includes: processing, using a first machine learning system, training data to determine a first plurality of outputs, each output of the first plurality of outputs corresponding to a layer of the first machine learning system; determining, based on a comparison of the first plurality of outputs to a second plurality of outputs associated with a second machine learning system, a layer-by-layer loss associated with the first machine learning system; and adjusting parameters of one or more layers of the first machine learning system based on the layer-by-layer loss.

In some aspects, a non-transitory computer-readable medium is provided having stored thereon instructions that, when executed by at least one processor, cause the at least one processor to: process, using a first machine learning system, training data to determine a first plurality of outputs, each output of the first plurality of outputs corresponding to a layer of the first machine learning system; determine, based on a comparison of the first plurality of outputs to a second plurality of outputs associated with a second machine learning system, a layer-by-layer loss associated with the first machine learning system; and adjust parameters of one or more layers of the first machine learning system based on the layer-by-layer loss.

In some aspects, an apparatus for machine learning system training distillation is provided. The apparatus includes: means for processing, using a first machine learning system, training data to determine a first plurality of outputs, each output of the first plurality of outputs corresponding to a layer of the first machine learning system; means for determining, based on a comparison of the first plurality of outputs to a second plurality of outputs associated with a second machine learning system, a layer-by-layer loss associated with the first machine learning system; and means for adjusting parameters of one or more layers of the first machine learning system based on the layer-by-layer loss.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with aspects of the present disclosure.

FIG. 2 illustrates an example U-Net machine learning system architecture for layer-by-layer training of a machine learning system, in accordance with aspects of the present disclosure.

FIG. 3 illustrates example training data to train a machine learning system, in accordance with aspects of the present disclosure;

FIG. 4A is a block diagram illustrating an example of a first phase of training distillation using distribution loss matching, in accordance with aspects of the present disclosure.

FIG. 4B is a block diagram illustrating a second phase of training distillation of a student system using GAN losses, in accordance with aspects of the present disclosure.

FIG. 5 is a flow diagram illustrating an example process of image processing, in accordance with aspects of the present disclosure.

FIG. 6 is a block diagram illustrating an example neural network, in accordance with aspects of the present disclosure.

FIG. 7 is a block diagram illustrating an example convolutional neural network, in accordance with aspects of the present disclosure.

FIG. 8 is a block diagram of an example transformer in accordance with aspects of the disclosure.

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, various image processing techniques can be used by machine learning systems (e.g., machine learning models) to perform inpainting, such as interpolation and diffusion models. Image inpainting can include editing a region of an image, such as adding objects to an image, filling in a missing area of an image, or repairing damaged regions of an image. Machine learning system architectures, such as neural networks can be used to learn contextual features of images to predict objects or edits to images which should be performed during inpainting. Other machine learning model architectures, such as Generative Adversarial Networks (GANs) can be used to generate edits to the image which can be applied to an image to perform inpainting. For example, the GAN can be a machine learning system used to enhance a quality of an input image to make the image closer to realism during training. The adversarial network can be dropped (e.g., not used) during inference. The GAN can be used to train a student network (e.g., a student machine learning network or student machine learning system). Traditional inpainting techniques however can be resource intensive. The resource intensive nature of traditional machine learning systems for inpainting make traditional machine learning systems difficult to execute on electronic devices where computing resources can be limited, such as a smartphone, tablet, laptop, etc.

Image inpainting techniques can include editing areas of images to fill in the area. In some examples, image inpainting can include blending portions of images into an area of the image to be inpainted. Further examples of inpainting can include using diffusion models, transformer architecture, neural networks, generative machine learning models, GANs, etc. to predict features of object or edit to be added to the image based on features of the of the image. In some examples, inpainting can be performed upon request of users. For example, various generative machine learning models can receive user prompts requesting performance of an edit, such as adding an object to an image.

Training and executing machine learning models can be a resource intensive. Many computing devices (e.g., smartphones, laptops, tablets, etc.) lack the computational resources to efficiently execute machine learning models which can perform inpainting techniques. Generally, to bypass this limitation of the computing devices, computing devices will communicate with edge devices, servers, or other computing devices or services, to perform the inpainting techniques and transmit an edited image back to the computing device. This alternative can introduce security concerns for users seeking to edit images which users would prefer not to share with an off-device machine learning system. For example, users concerned about personally identifiable information (PII), or biometric information being stored or being used to train off-device machine learning systems may avoid the aforementioned off-device machine learning systems out of concern for privacy and security. Improvements to the operation of machine learning systems can allow for more machine learning systems to be operated on devices with lower computational constraints (e.g., devices having lower processing power, lower computational resources, etc.).

One example can include using smaller machine learning systems (e.g., machine learning systems with fewer parameters, fewer layers, etc.) to perform tasks such as inpainting. Smaller machine learning systems are generally less accurate than more complex machine learning systems due in part to the reduced number of parameters and layers. Machine learning system training techniques such as training distillation (also referred to as knowledge distillation or distillation) can be used to transfer learning from a larger machine learning system (e.g., a teacher system) to a smaller machine learning system (e.g., a student system). For example, the teacher system can represent a pre-trained machine learning system larger than the student system (e.g., having more parameters, more layers, etc.).

The teacher system can be used to train the student system to approximate the outputs of the teacher system. In one example, the training distillation can include training a student system using probability distributions generated by the teacher system to adjust parameters of the student system such that the outputs of the student system approximate the outputs of the teacher system. The training process can be an iterative process. For example, the student system and the teacher system can receive inputs and generate outputs. Training can include comparing the outputs to determine a loss and adjusting the parameters of the student system based on the loss. The training process can continue until the student system generates outputs within a predetermined error tolerance of the teacher system such that the student system approximates the outputs of the teacher system.

Systems, apparatuses, electronic devices, methods (also referred to as processes), and computer-readable media (collectively referred to herein as “systems and techniques”) are described herein for training distillation (e.g., knowledge distillation) techniques for inpainting machine learning systems. The machine learning system can include one or more machine learning models, such as U-Net convolutional neural network (CNN) architecture. The machine learning system can include multiple machine learning models (also referred to herein as machine learning systems) such as a teacher system, a student system, a GAN, and a fake teacher system.

A fake teacher system can refer to a machine learning system trained using synthetic or fake images. In such an example, the fake teacher system can be a machine learning system for inpainting trained using synthetic images of objects. In other examples, the fake teacher system can be trained using images including added noise or images including predetermined characteristics such that the model generates biased, distorted, or inaccurate outputs. In further examples, the teacher system (also referred to as the real teacher system) can be trained using real images (e.g., real-world images or other images used to train the teacher system to generate accurate outputs).

In some aspects, the systems and techniques can include pruning a machine learning model to remove layers of the machine learning model (e.g., a student system based on layer-by-layer training using a teacher system). For example, the student system can be a first machine learning system, and the teacher system can be a second machine learning system. The teacher system and the student system can use U-Net architecture. In such an example, the student system and the teacher system can have use the same downsampling layers (e.g., different instances of the same downsampling layers) of U-Net architecture and different upsampling layers of U-Net architecture. By way of a non-limiting example, the student system can be pruned by removing cross-attention layers and self-attention layers of upsampling layers of the U-Net. For example, a decoder portion of the U-Net (e.g., the upsampling portion of the U-Net) can include fewer cross-attention layers at higher layers of the decoder (e.g., layers closer to an encoder of the U-Net) and few self-attention layers at lower layers of the decoder (e.g., layers closer to the output of the decoder) compared to corresponding upsampling layers of the teacher system.

In some aspects, the downsampling layers of the U-Net architecture (e.g., an encoder portion of the U-Net architecture) can include differences between the student system and the teacher system. For example, the downsampling layers can include fewer cross-attention layers and self-attention layers than the teacher system. The reduction in the size of the student system (e.g., pruning of cross-attention and self-attention layers from the encoder and decoder portions of the U-Net) can reduce the computational resources required to operate the student system.

In some aspects, the teacher system and the student system can be diffusion machine learning models. The student system can process training data to determine a first plurality of outputs. The first plurality of outputs can correspond to a layer of the student system. For example, each output of the first plurality of outputs can correspond to a layer of the student system. In some examples, the outputs can be or include activations of a layer of the student system.

In some examples, the training data can include images, noise (e.g., random noise, random Gaussian noise distribution, etc.), and a mask. For example, the mask can include matrix of 1s and 0s indicating pixels of the image which should be inpainted (e.g., areas of the image which an object or edit should be applied). The student system and the teacher system can receive the training data as input and generate outputs. The systems and techniques can include comparing the outputs of the teacher system and the student system to determine layer-by-layer loss of the student system.

In some aspects, the systems and techniques can include adjusting parameters of the student system based on the layer-by-layer loss. For example, the systems and techniques can include using a loss function such as mean squared error (MSE), mean absolute error (MAE), Kullback-Leibler divergence (e.g., relative entropy loss functions), or other loss functions to adjust the parameters of the student system based on differences between the outputs of the student system and the teacher system.

In some aspects, the systems and techniques can include using distribution matching of the student system, the teacher system, and the fake teacher system to train the student system. For example, the distribution matching training process for training distillation can be a two-phase training process. In such an example, the first phase can include training the student system based on a distribution matching loss of the teacher system, student system, and the fake teacher system. The second phase can include training the fake teacher system and an adversarial network (e.g., a GAN) based on a GAN loss between outputs of the fake teacher system, the adversarial network, and the teacher system.

For example, the first phase of the distribution matching training process for training distillation can include determining a distribution loss of the student system. In some aspects, the student system can receive a first image including noise. For example, the first image can include a random distribution of noise. The student system, which can be the pruned U-Net architecture trained using layer-by-layer training, can process the first image including noise to generate a denoised representation of the first image. The teacher system and the fake teacher system can process the first image to generate a second denoised representation of the first image and a third denoised representation of the first image respectively. The systems and techniques can include comparing the first denoised representation, the second denoised representation, and the third denoised representation to determine a distribution loss of the student system. In some examples, the systems and techniques can include comparing the output of the student system and the teacher system.

In some aspects, the systems and techniques can include adjusting parameters of the student system based on the distribution loss to provide an adjusted student system (e.g., an adjusted first machine learning system or trained student system). For example, the systems and techniques can include adjusting weights of the student system to adjust the student system to reduce a loss function. In some examples, the student system can be trained over multiple iterations of the first phase. For example, subsequent images can be processed by the student system, teacher system, and the fake teacher system to determine subsequent distribution losses. The iterations can continue until a hyperparameter of the training (e.g., a predetermined number of iterations, or when the output of the student system generates a loss below a predetermined threshold) indicates the training should transition to the second phase.

In some aspects, the systems and techniques can include adjusting parameters of the student system based on a combined loss of the distribution loss and a GAN loss associated with a comparison of the output of the adversarial network and the output of the student system, teacher system, and the fake teacher system. In such an example, the GAN loss and the distribution loss can be summed. The combined loss of the distribution loss and the GAN loss can be used to adjust parameters of the student system to reduce a loss function associated with the combined loss.

In some aspects, the systems and techniques can include processing an additional image including noise using the adjusted student system (e.g., the student system trained during the first phase) to generate a denoised representation of the additional image (e.g., a second image). For example, the denoised representation of the additional image can be an image or an embedding representation of the additional image. In some aspects, the systems and techniques can include adding noise to the output of the student system (e.g., adding noise to the denoised representation of the additional image or to the additional image output by the student system). The fake teacher system, the teacher system, and the adversarial network (e.g., the GAN) can process the additional image including noise to generate further denoised representations of the additional image (e.g., a first denoised representation of the second image, a second denoised representation of the second image, etc.).

In some aspects, the systems and techniques can include determining a GAN loss associated with the fake teacher system and the adversarial network. For example, the GAN loss can represent differences in the output of the student system, the fake teacher system, and the adversarial network. The systems and techniques can include adjusting parameters of the fake teacher system and the adversarial system to reduce a loss function associated with the GAN loss. In some examples, the second phase of the training can be iterative. For example, subsequent images can be generated by the student system to be processed by the fake teacher and adversarial network. In some examples, an iteration of the training process can include a first iteration of the first phase and a corresponding iteration of the second phase. In such an example, subsequent iterations of the training process can include a subsequent iteration of the first phase and a corresponding iteration of the second phase (e.g., the training process can include transitioning between phases every iteration). In other examples, the first phase can be performed until a hyperparameter of the training process indicates the training process should transition to the second phase.

In some aspects, the systems and techniques can include performing the training phases on-device. In further examples, the systems and techniques can include using the trained student system to perform inpainting. In such an example, the trained student system can be deployed to a device or apparatus. In a further example, the adversarial network can be dropped (e.g., unloaded from a device, or not initially loaded to memory of the device) during inference. In another example, the trained student system can receive conditions, such as a user prompt and an image. The user prompt can include text-based instructions from a user requesting inpainting, such as adding an object to the image. In some examples, the user prompt can include a mask indicating an area of the image to which the inpainting should be applied. The trained student system can process the user prompt and the image to generate perform the request.

Various aspects of the present disclosure will be described with respect to the figures.

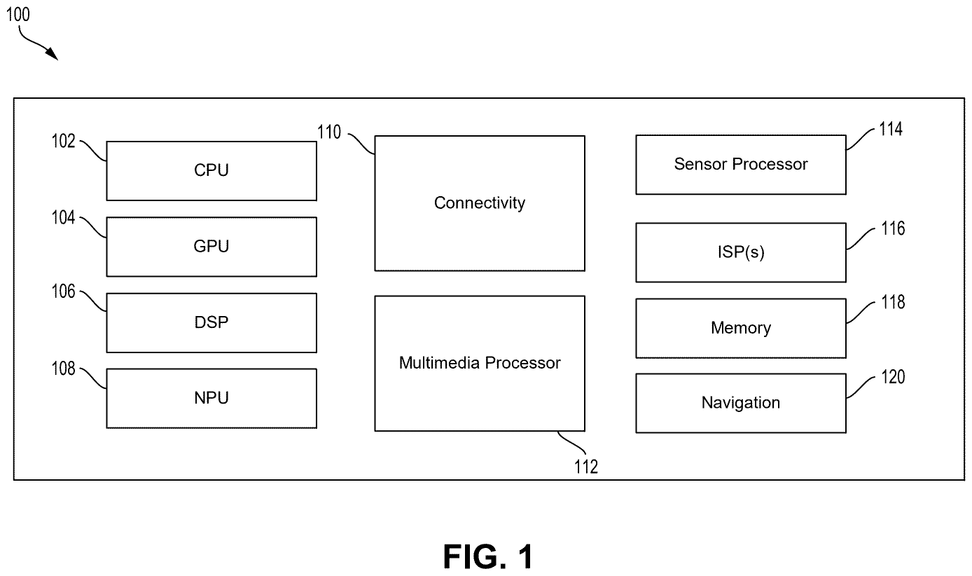

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

For example, the use of recurrent connections and/or temporal information in a machine learning model for inpainting, such as denoising of images and adding objects to areas of the image, can be used to preserve characteristics of the image including noise, to achieve higher quality images (e.g., denoised images and images including the inpainting). Various recurrent architectures (e.g., RNNs) that include one or more recurrent cells among the feed-forward layers of the network can be used to perform audio processing operations to generate processed output audio signals having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

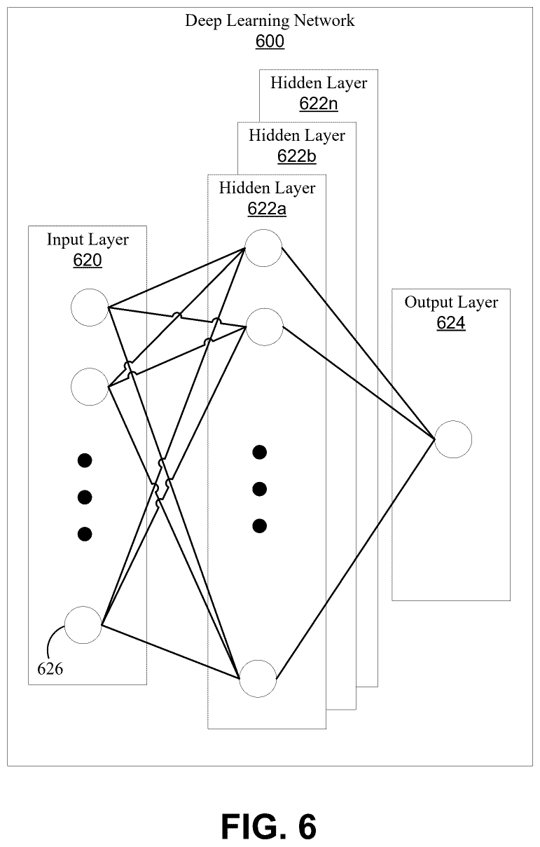

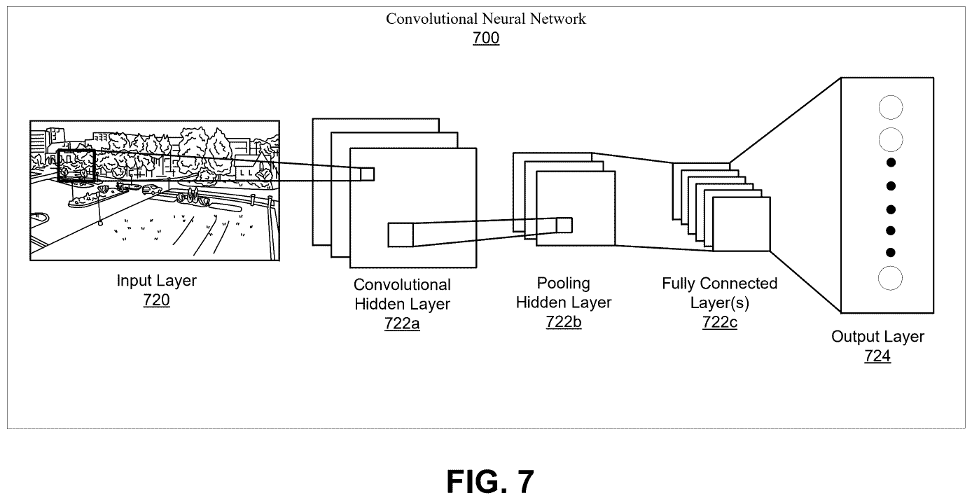

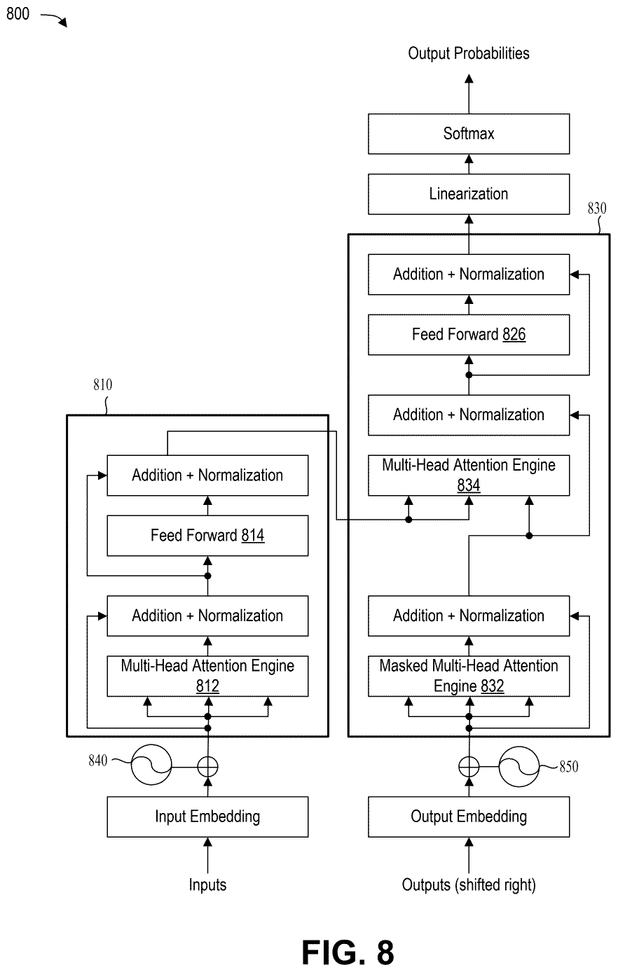

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 6, FIG. 7, and FIG. 8.

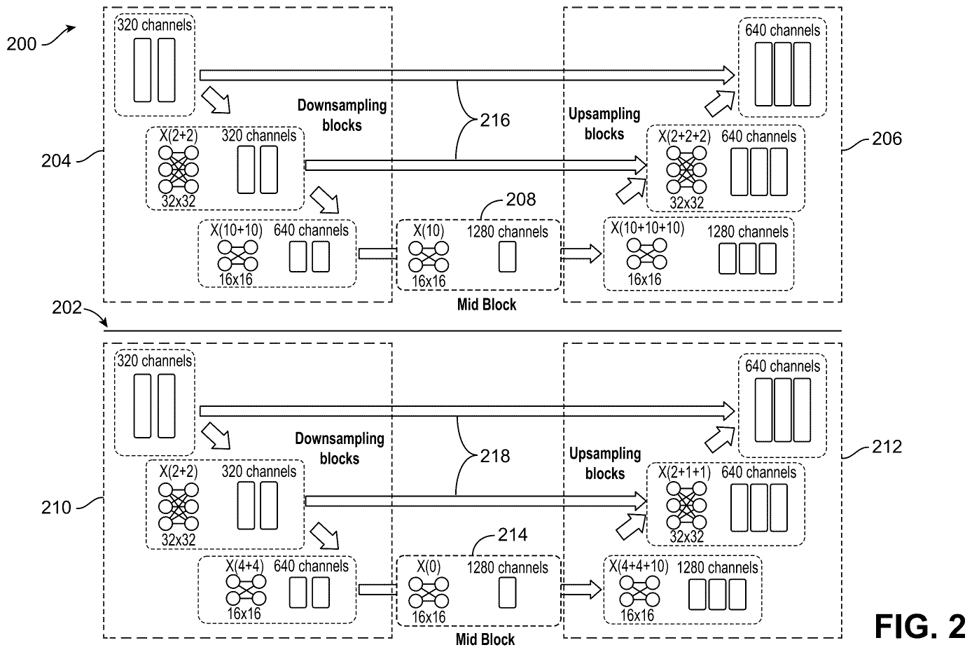

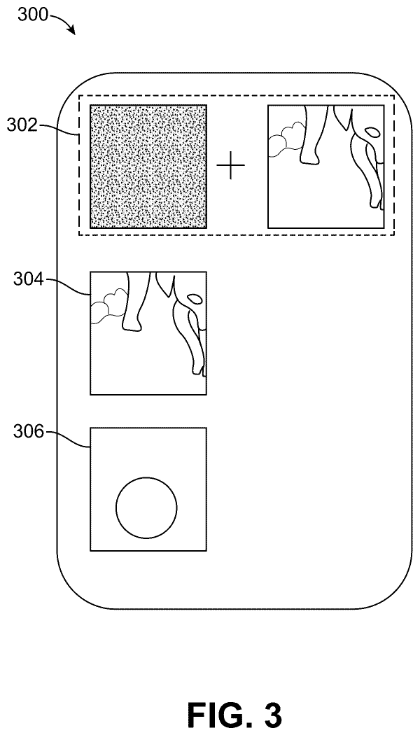

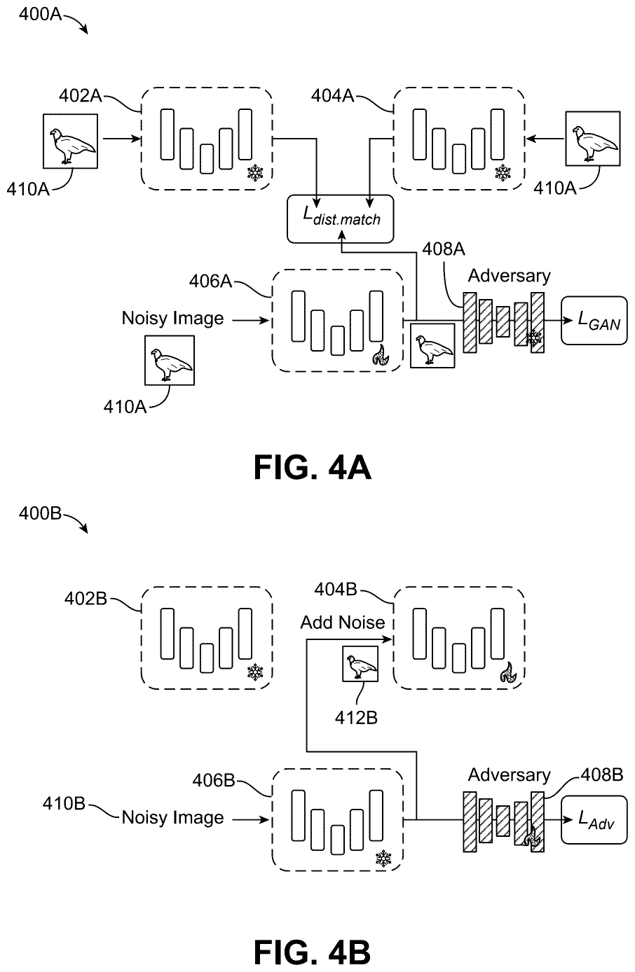

The SOC 100 of FIG. 1 can be used to perform the various systems and techniques described in the descriptions of FIG. 2-FIG. 5. For example, the SOC 100 can be used to perform operations of the machine learning systems described in the description of FIG. 2, FIG. 3, FIG. 4A, and FIG. 4B including inpainting operations.

FIG. 2 is a block diagram illustrating example U-Net architecture including base U-Net architecture 200 and a pruned U-Net architecture 202 for training distillation. For example, the base U-Net architecture 200 can be a teacher system (e.g., a teacher machine learning model) configured to train a student system (e.g., a student machine learning model). The pruned U-Net architecture 202 can be a student system of the teacher system (e.g., of the base U-Net architecture 200).

The base U-Net architecture 200 can include an encoder 204 represented by the downsampling blocks of the base U-Net architecture 200 and a decoder 206 represented by the upsampling blocks of the base U-Net architecture 200. The encoder 204 and the decoder 206 can include various cross-attention layers and self-attention layers. The downsampling blocks of the encoder 204 can include various additional layers to process an input image (or image representation) to the base U-Net architecture 200. For example, the downsampling blocks can include various neural network layers such as convolutional layers, recurrent layers, fully connected layers, feedforward networks, MLPs, etc. The encoder 204 can include skip connections 216 between layers of the encoder 204 and corresponding layers of the decoder 206.

The base U-Net architecture 200 can include a middle cross-attention block 208 positioned between the encoder 204 and the decoder 206. The middle cross-attention block 208 can process outputs of the encoder 204 to refine a feature map representation of an input image with noise to the base U-Net architecture 200. The middle cross-attention block 208 output the refined feature map representation to the decoder 206 for generation of a denoised image representation of the input image.

The pruned U-Net architecture 202 can be a machine learning system of reduced size compared to the base U-Net architecture 200. For example, the pruned U-Net architecture 202 can be substantially the same architecture as the base U-Net architecture 200 with fewer parameters and fewer layers. For example, the pruned U-Net architecture 202 includes an encoder 210 associated with downsampling blocks of the pruned U-Net architecture 202. The pruned U-Net architecture 202 includes a decoder 212 associated with upsampling blocks of the pruned U-Net architecture 202. The pruned U-Net architecture 202 includes a middle cross-attention block 214 positioned between the encoder 210 and the decoder 212 to refine a feature map representation of an input image to the pruned U-Net architecture 202. The pruned U-Net architecture 202 can use the refined feature map to construct a denoised representation of the image.

The encoder 210 and the decoder 212 of the pruned U-Net architecture 202 can include fewer parameters and layers compared to the base U-Net architecture 200. For example, to reduce the size of the pruned U-Net architecture 202, the pruned U-Net architecture 202 can have fewer cross-attention layers and fewer self-attention layers than the base U-Net architecture 200. In further examples, the pruned U-Net architecture 202 can include skip connections 218 between layers of the encoder 210 and the decoder 212. The decoder 212 can include fewer cross-attention layers in upsampling layers of the decoder 212 compared to corresponding upsampling layers of the decoder 206.

The base U-Net architecture 200 can be used as a teacher system (e.g., a teacher machine learning model) to train the pruned U-Net architecture 202 as a student system (e.g., a student machine learning model) layer-by-layer. For example, the base U-Net architecture 200 can receive input data (e.g., training data) to train the pruned U-Net architecture 202. The training data can include an image with noise and a mask. For example, the image can include a random distribution of noise applied to the image. In further examples, the mask can be an array of 1s and 0s representing pixel locations of the image to which inpainting should be applied.

The base U-Net architecture 200 and the pruned U-Net architecture can process the training data. Training the pruned U-Net architecture can include determining loss between the pruned U-Net architecture and base U-Net architecture 200 associated with layers of the U-Net architecture 200. Parameters of the pruned U-Net architecture 202 can be adjusted based on the layer-by-layer loss of the pruned U-Net architecture 202 to reduce a loss function associated with the layer-by-layer loss training. For example, the loss function can be various loss functions used for regression tasks such as MSE and MAE loss functions. In some examples, the loss function can be different layer-by-layer. For example, a convolutional layer of the U-Net architectures can be associated with a first loss function and an output layer of the U-Net architectures can be associated with a second loss function.

FIG. 3 is a block diagram illustrating example input data 300 used to train the pruned U-Net architecture 202 of FIG. 2. For example, the input data 300 includes an image with noise (e.g., a noisy image 302). The noise can be a random distribution of noise added to the image. For example, the pruned U-Net architecture 202 can be a diffusion machine learning model configured to denoise images and perform inpainting.

The input data 300 can include an image without the noise added (e.g., a training image 304). In further examples, the input data 300 can include a mask 306. The mask can be an array or matrix of binary values (e.g., 1s and 0s) indicating an area of the training image 304 which inpainting should be applied. For example, the matrix of binary values representing the mask 306 can represent pixel locations of the training image 304 which should be edited to perform inpainting. For example, editing can include adjusting pixel values associated with pixels corresponding to the mask to represent an object or other adjustment to a scene represented in the training image 304.

FIG. 4A is a block diagram illustrating an example of a first phase 400A of training distillation using distribution loss matching. The first phase 400A can include training the student system 406A (e.g., a student machine learning model or machine learning system) based on a distribution loss of a teacher system 402A and a fake teacher system 404A. For example, the fake teacher system 404A can be machine learning system trained using synthetic (e.g., fake) images. For example, the fake teacher system 404A can be trained on images to provide biased, distorted, or inaccurate outputs. In some examples, the student system can be the pruned U-Net architecture 202 described in the description of FIG. 2 and the teacher system 402A can be the base U-Net architecture 200 described in the description of FIG. 2.

The first phase 400A can include receiving a noisy image 410A (e.g., an image including a noise such as a random distribution of noise). The noisy image 410A can be processed by the teacher system 402A, the fake teacher system 404A and the student system 406A to generate denoised image representations of the noisy image 410A. The first phase 400A can include comparing the denoised image representations of the teacher system 402A, the fake teacher system 404A, and the student system 406A to determine a distribution loss matching associated with the student system 406A. In some examples, the distribution loss can be represented as an array of probabilities associated with predictions of pixel values of a denoised image, such as a denoised image including inpainting.

The first phase 400A can include adjusting parameters of the student system 406A based on the distribution losses. In some examples, the parameters of the student system 406A can be adjusted based on a combination of the distribution losses and GAN losses of an adversarial network 408A (e.g., a generative adversarial network). For example, the parameters of the student system can be adjusted based on a combined loss of the distribution loss and a GAN loss associated with a comparison of the output of the adversarial network 408A and the output of the student system 406A, teacher system 402A, and the fake teacher system 404A. In further examples, the GAN loss can be associated with a comparison of an output (e.g., a denoised representation of an image) of the adversarial network 408A and a ground truth image. For example, the output of the adversarial network 408A can be compared to the output of the teacher system 402A to determine the GAN loss. In such an example, the GAN loss and the distribution loss can be summed to determine a combined loss. The combined loss of the distribution loss and the GAN loss can be used to adjust parameters of the student system to reduce a loss function associated with the combined loss.

In some examples, the student system 406A can be trained over multiple iterations of the first phase 400A. For example, subsequent noisy images can be processed by the student system 406A, teacher system 402A, and the fake teacher system 404A to determine further distribution losses or combined losses. The iterations can continue until a hyperparameter of the first phase 400A (e.g., a training hyperparameter) indicates the training should proceed to a second phase. In some examples, the hyperparameter can include a predetermined number of iterations or a minimum loss value triggering transition to the second phase of training.

FIG. 4B is a block diagram illustrating a second phase 400B of training distillation using GAN losses of an adversarial network. The second phase 400B can include training the fake teacher system 404B and the adversarial network 408B based on GAN losses. For example, the student system 406B can receive a noisy image 410B. The student system can process the noisy image 410B to determine a denoised image representation of the noisy image. The fake teacher system 404B can receive the denoised image representation and add noise back to the denoised image representation to generate a noisy image representation 412B of the image input to the student system 406B. In further examples, a teacher system 402B and the adversarial network 408B can receive the denoised image representation output by the student system and add noise to the generate a noisy image representation 412B of the image.

The teacher system 402B, the fake teacher system 404B, and the adversarial network 408B can generate a denoised representation of the noisy image representation 412B. The second phase 400B can include comparing the noisy image representation 412B generated by the teacher system 402B, the fake teacher system 404B, and the adversarial network 408B to determine a GAN loss. The second phase 400B can include using a loss function associated with the GAN loss to adjust parameters of the fake teacher system 404B and the adversarial network 408B to train the fake teacher system 404B and the adversarial network 408B. For example, the student system 406B can be trained to mimic the teacher system 402B using a reduced architecture (e.g., fewer layers of a machine learning system or fewer parameters) and using fewer training iterations (e.g., fewer epochs or batches).

In some aspects, training of one or more of the machine learning systems or neural networks described herein (e.g., such as the machine learning systems of FIG. 2, FIG. 3, FIG. 4A, and FIG. 4B, among various other machine learning networks and models described herein) can be performed using online training (e.g., in some case on-device training), offline training, and/or various combinations of online and offline training. In some cases, online can refer to time periods during which the input data (e.g., such as the sensor data, images, masks) is processed, for example for performance of optimizing loss weights of the loss function to reduce losses while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

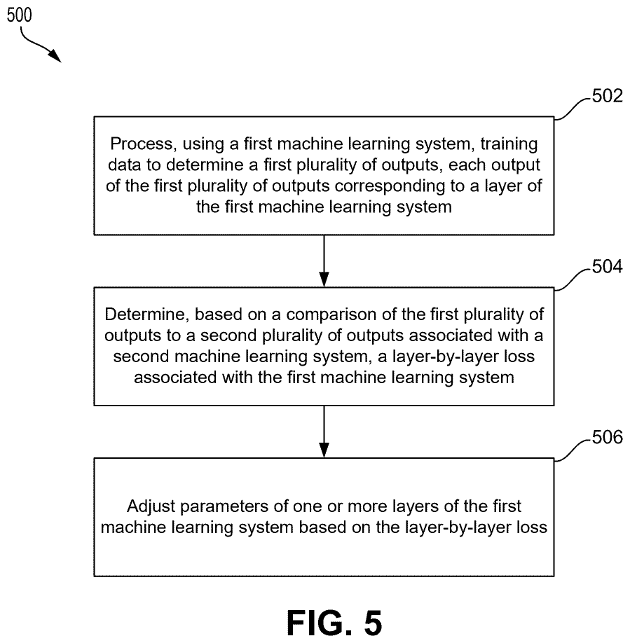

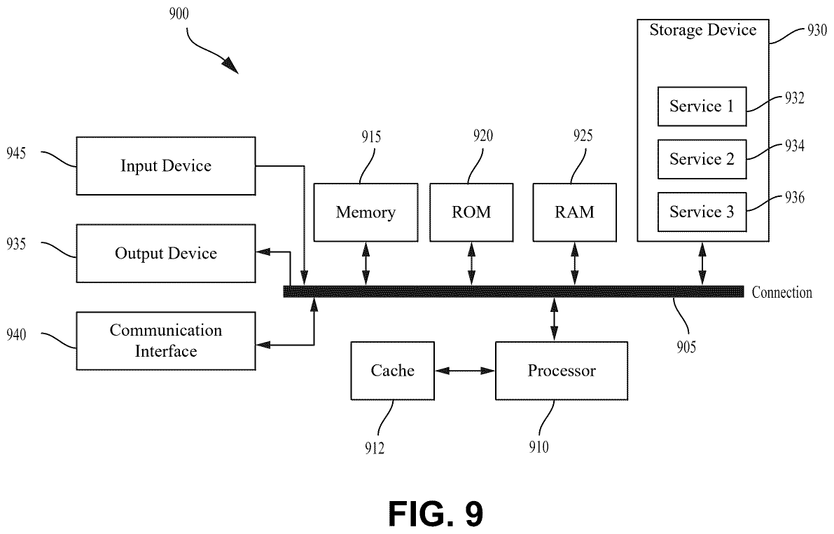

FIG. 5 is a flow diagram illustrating an example process 500 for machine learning system training distillation. The process 500 can be performed by a computing device (e.g., SOC 100 of FIG. 1, computing device or computing system 900 of FIG. 9, etc.) or by a component or system (e.g., the machine learning systems of FIG. 2, the machine learning systems of FIG. 4A and FIG. 4B, etc.), a chipset, one or more processors central processing units (CPUs), digital signal processors (DSPs), graphics processing units (GPUs), any other type of processor(s), any combination thereof, or other component or system) of the computing device. The operations of the process 500 can be implemented as software components that are executed and run on one or more processors (e.g., processor 910 of FIG. 9 or other processor(s)) of the computing device. Further, the transmission and reception of signals by the computing device in the process 500 can be enabled, for example, by one or more antennas, one or more microphones, and/or one or more transceivers (e.g., wireless transceiver(s)).

At block 502, the computing device (or component thereof) can process training data to determine a first plurality of outputs. In some examples, the training data can include images, noise (such as random noise, random Gaussian noise distribution, etc.), and a mask. For example, the training data can include the input data 300 of FIG. 3. In such an example, the mask can be a matrix of values (e.g., binary values 1s and 0s) indicating pixels of the image which should be inpainted. For example, the mask can indicate which pixels of the image (e.g., a training image such as the training image 304 of FIG. 3) should be inpainted. In a further example, the mask can indicate an area of the training image for the first machine learning system to edit. For example, the edit can include an addition of an object to the training image.

In further examples, the first plurality of outputs can include output activations corresponding to a layer of the first machine learning system. For example, each layer of the first machine learning system (or each block of the machine learning system representing a plurality of layers) can be included in the first plurality of outputs. In some examples, the first machine learning system can include a neural network using U-Net architecture, such as the pruned U-Net architecture 202 of FIG. 2. The first machine learning network can include a plurality of self-attention layers, cross-attention layers, convolutional layers, etc. The first machine learning network can be a student machine learning system, such as the student system 406A of FIG. 4A and the student system 406B of FIG. 4B in a student teacher training distillation system.

At block 504, the computing device (or component thereof) can determine a layer-by-layer loss associated with the first machine learning system. For example, the determination can be based on a comparison of the first plurality of outputs to a second plurality of outputs associated with a second machine learning system. In some examples, the second machine learning system can include U-Net architecture, such as the base U-Net architecture 200 of FIG. 2. The layer-by layer loss can represent a comparison of a plurality of outputs of blocks from the first machine learning network and a plurality of outputs of blocks from the second machine learning network. In some examples, the second machine learning system is trained using data associated with synthetic images (e.g., fake images such as images generated by another machine learning system). In some examples, the first machine learning system can include fewer self-attention layers in one or more upsampling layers of the first machine learning system compared to corresponding upsampling layers of the second machine learning system. In another example, the first machine learning system includes fewer cross-attention layers in one or more upsampling layers of the first machine learning system compared to corresponding upsampling layers of the second machine learning system. In further examples, the second machine learning system can be a teacher system, such as the teacher system 402A of FIG. 4A and the teacher system 402B of FIG. 4B.

At block 506, the computing device (or component thereof) can adjust parameters of one or more layers of the first machine learning system based on the layer-by-layer loss. For example, the parameters of the one or more layers (or blocks) of the first machine learning system can be adjusted to reduce a loss function of the first machine learning system. In some examples, the first machine learning system is trained using on-device training.

In some examples, the computing device (or component thereof) can determine a distribution loss based on output images of the first machine learning system, the second machine learning system, and a third machine learning system. In some examples, the third machine learning system can be the fake teacher system 404A of FIG. 4A or the fake teacher system 404B of FIG. 4B. In further examples, the distribution loss can be based on a comparison of a first denoised representation of a first image to a second denoised representation of the first image generated by the second machine learning system and a third denoised representation of the first image generated by the third machine learning system. In such an example, the first machine learning system, the second machine learning system, and the third machine learning system can receive noisy image representations of the first image and output denoised representations of the first image (e.g., images removing the noise). In further examples, the computing device (or component thereof) can adjust parameters of the first machine learning system based on the distribution loss to provide an adjusted first machine learning system. For example, the computing device (or component thereof) can adjust parameters of the first machine learning system to reduce a loss function and fine-tune the first machine learning system (e.g., to generate an adjusted first machine learning system). In further examples, the third machine learning system can be trained using data associated with real images.

In further examples, the computing device (or component thereof) can generate a second image using the adjusted first machine learning system. The computing device (or component thereof) can process the second image to generate a first denoised representation of the second image and a second denoised representation of the second image. For example, the first machine learning system can receive an image with noise and generate the second image with the noise removed. The systems and techniques can include adding noise to the second image and providing the second image to the third machine learning system. The second machine learning system and the third machine learning system can generate a first denoised representation of the second image and a second denoised representation of the second image. The computing device (or component thereof) can determine, based on a comparison of the first denoised representation of the second image and a second denoised representation of the second image, an additional loss associated with the second machine learning system (e.g., an additional distribution loss associated with the second machine learning system).

In further examples, the computing device (or component thereof) can process, using an adversarial network, the second image to determine a GAN loss associated with the adversarial network. For example, an adversarial network (e.g., an adversarial network part of a GAN) can process images to determine whether an image is real (e.g., images generated by a teacher system such as the second machine learning system) or fake (e.g., an image generated by a student system such as the first machine learning system). The computing device (or component thereof) can compare the determination of the adversarial network to a ground truth such as a label of the images to determine the GAN loss. In such an example, the student network (e.g., the first machine learning system) is to be trained to mimic the teacher network (e.g., the second machine learning system). In such an example, training the student system such that the adversarial network determines that images output by the student system are images output by the teacher system (e.g., making outputs of the student system substantially indistinguishable from output of the teacher system as determined by the adversarial network) can be the objective of training the student system. In further examples, the computing device (or component thereof) can adjust parameters of the second machine learning system based on the GAN loss and the additional loss to provide an adjusted second machine learning system. In further examples, the adversarial network can be trained based on the GAN loss and the additional loss.

FIG. 6 is an illustrative example of a deep learning neural network 600 that can be used by a machine learning system. An input layer 620 includes input data. In one illustrative example, the input layer 620 can include data representing the pixels of an input image or video frame. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 624 that provides an output resulting from the processing performed by the hidden layers 622a, 622b, through 622n. In one illustrative example, the output layer 624 can provide a classification for an object in an input image or video frame. The classification can include a class identifying the type of object (e.g., a static object, a vehicle, a person, a dog, a cat, or other object).

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the hidden layers 622a, 622b, through 622n can transform the information of each input node by applying activation functions to the information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 624, at which an output is provided. In some cases, while nodes (e.g., node 626) in the neural network 600 are shown as having multiple output lines, a node has a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 624. In an example in which the neural network 600 is used to identify objects in images, the neural network 600 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 600 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 600 is trained well enough so that the weights of the layers are accurately tuned.

For the example of identifying objects in images, the forward pass can include passing a training image through the neural network 600. The weights are initially randomized before the neural network 600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as Eₜₒₜₐₗ=Σ½(target−output)², which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 600 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and [symbol] denotes a learning rate. The learning rate can be set to any suitable value, with a high learning rate including larger weight updates and a lower value indicating smaller weight updates.

The neural network 600 can include any suitable deep network. One example includes a convolutional neural network (CNN), which includes an input layer and an output layer, with multiple hidden layers between the input and out layers. An example of a CNN is described below with respect to FIG. 6. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

FIG. 7 is an illustrative example of a convolutional neural network 700 (CNN 700). The input layer 720 of the CNN 700 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 722a, an optional non-linear activation layer, a pooling hidden layer 722b, and fully connected hidden layers 722c to get an output at the output layer 724. While only one of each hidden layer is shown in FIG. 7, one of ordinary skill will appreciate that multiple convolutional hidden layers, non-linear layers, pooling hidden layers, and/or fully connected layers can be included in the CNN 700. As previously described, the output can indicate a single class of an object or can include a probability of classes that best describe the object in the image.

The first layer of the CNN 700 is the convolutional hidden layer 722a. The convolutional hidden layer 722a analyzes the image data of the input layer 720. Each node of the convolutional hidden layer 722a is connected to a region of nodes (pixels) of the input image called a receptive field. The convolutional hidden layer 722a can be considered as one or more filters (each filter corresponding to a different activation or feature map), with each convolutional iteration of a filter being a node or neuron of the convolutional hidden layer 722a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 722a. Each connection between a node and a receptive field for that node learns a weight and, in some cases, an overall bias such that each node learns to analyze its particular local receptive field in the input image. Each node of the hidden layer 722a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 722a is due to each node of the convolutional layer being applied to its corresponding receptive field. For example, a filter of the convolutional hidden layer 722a can begin in the top-left corner of the input image array and can convolve around the input image. As noted above, each convolutional iteration of the filter can be considered a node or neuron of the convolutional hidden layer 722a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 722a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 722a.

The mapping from the input layer to the convolutional hidden layer 722a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 722a can include several activation maps in order to identify multiple features in an image. The example shown in FIG. 7 includes three activation maps. Using three activation maps, the convolutional hidden layer 722a can detect three different kinds of features, with each feature being detectable across the entire image.

In some examples, a non-linear hidden layer can be applied after the convolutional hidden layer 722a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 700 without affecting the receptive fields of the convolutional hidden layer 722a.

The pooling hidden layer 722b can be applied after the convolutional hidden layer 722a (and after the non-linear hidden layer when used). The pooling hidden layer 722b is used to simplify the information in the output from the convolutional hidden layer 722a. For example, the pooling hidden layer 722b can take each activation map output from the convolutional hidden layer 722a and generates a condensed activation map (or feature map) using a pooling function. Max-pooling is one example of a function performed by a pooling hidden layer. Other forms of pooling functions be used by the pooling hidden layer 722a, such as average pooling, L2-norm pooling, or other suitable pooling functions. A pooling function (e.g., a max-pooling filter, an L2-norm filter, or other suitable pooling filter) is applied to each activation map included in the convolutional hidden layer 722a. In the example shown in FIG. 7, three pooling filters are used for the three activation maps in the convolutional hidden layer 722a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 722a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 722a having a dimension of 24×24 nodes, the output from the pooling hidden layer 722b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 722b to every one of the output nodes in the output layer 724. Using the example above, the input layer includes 28×28 nodes encoding the pixel intensities of the input image, the convolutional hidden layer 722a includes 3×24×24 hidden feature nodes based on application of a 5×5 local receptive field (for the filters) to three activation maps, and the pooling layer 722b includes a layer of 3×12×12 hidden feature nodes based on application of max-pooling filter to 2×2 regions across each of the three feature maps. Extending this example, the output layer 724 can include ten output nodes. In such an example, every node of the 3×12×12 pooling hidden layer 722b is connected to every node of the output layer 724.

The fully connected layer 722c can obtain the output of the previous pooling layer 722b (which should represent the activation maps of high-level features) and determines the features that most correlate to a particular class. For example, the fully connected layer 722c layer can determine the high-level features that most strongly correlate to a particular class and can include weights (nodes) for the high-level features. A product can be computed between the weights of the fully connected layer 722c and the pooling hidden layer 722b to obtain probabilities for the different classes. For example, if the CNN 700 is being used to predict that an object in an image or video frame is a vehicle, high values will be present in the activation maps that represent high-level features of vehicles (e.g., two or four tires, a windshield, side view mirrors, etc.).

In some examples, the output from the output layer 724 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

FIG. 8 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 800 reduces the operations of learning dependencies by using an encoder 810 and a decoder 830 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 810 is composed of a stack of six identical layers and each layer has two sub-layers. The first sub-layer is a multi-head self-attention engine 812, and the second sub-layer is a fully connected feed-forward network 814. A residual connection (not shown) connects around each of the sub-layers followed by normalization.

In this example transformer 800, the decoder 830 is also composed of a stack of six 6 identical layers. The decoder also includes a masked multi-head self-attention engine 832, a multi-head attention engine 834 over the output of the encoder 810, and a fully connected feed-forward network 826. Each layer includes a residual connection (not shown) around the layer, which is followed by layer normalization. The masked multi-head self-attention engine 832 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 840 to encode positions because the model does not contain recurrence and convolution, and relative or absolute position of the tokens is needed. In the transformer 800, the positional encodings are added to the input embeddings at the bottom layer of the encoder 810 and the decoder 830. The positional encodings are summed with the embeddings because the positional encodings and embeddings have the same dimensions. A corresponding position decoder 850 is configured to decode the positions of the embeddings for the decoder 830.

In some aspects, the transformer 800 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 800 can process input sequences of variable length, making it well-suited for natural language processing tasks where input lengths can vary greatly. Additionally, the self-attention mechanism allows the transformer 800 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 9 illustrates an example computing system 900 of an example computing device which can implement the various techniques described herein. For example, the computing system 900 can implement the machine learning system shown in FIG. 4A and FIG. 4B. The components of computing system 900 are shown in electrical communication with each other using connection 905, such as a bus. The example computing system 900 includes a processing unit (CPU or processor) 910 and computing device connection 905 that couples various computing device components including computing device memory 915, such as read only memory (ROM) 920 and random access memory (RAM) 925, to processor 910.

Computing system 900 can include a cache of high-speed memory connected directly with, in close proximity to, or integrated as part of processor 910. Computing system 900 can copy data from memory 915 and/or the storage device 930 to cache 912 for quick access by processor 910. In this way, the cache can provide a performance boost that avoids processor 910 delays while waiting for data. These and other modules can control or be configured to control processor 910 to perform various actions. Other computing device memory 915 may be available for use as well. Memory 915 can include multiple different types of memory with different performance characteristics. Processor 910 can include any general purpose processor and a hardware or software service, such as service 1 932, service 2 934, and service 3 936 stored in storage device 930, configured to control processor 910 as well as a special-purpose processor where software instructions are incorporated into the processor design. Processor 910 may be a self-contained system, containing multiple cores or processors, a bus, memory controller, cache, etc. A multi-core processor may be symmetric or asymmetric.

To enable user interaction with the computing system 900, input device 945 can represent any number of input mechanisms, such as a microphone for speech, a touch-sensitive screen for gesture or graphical input, keyboard, mouse, motion input, speech and so forth. Output device 935 can also be one or more of a number of output mechanisms known to those of skill in the art, such as a display, projector, television, speaker device, etc. In some instances, multimodal computing devices can enable a user to provide multiple types of input to communicate with computing system 900. Communication interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. Storage device 930 can include services 932, 934, 936 for controlling processor 910. Other hardware or software modules are contemplated. Storage device 930 can be connected to the computing device connection 905. In one aspect, a hardware module that performs a particular function can include the software component stored in a computer-readable medium in connection with the necessary hardware components, such as processor 910, connection 905, output device 935, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for machine learning system training distillation, the apparatus comprising: at least one memory; and at least one processor coupled to the at least one memory and configured to: process, using a first machine learning system, training data to determine a first plurality of outputs, each output of the first plurality of outputs corresponding to a layer of the first machine learning system; determine, based on a comparison of the first plurality of outputs to a second plurality of outputs associated with a second machine learning system, a layer-by-layer loss associated with the first machine learning system; and adjust parameters of one or more layers of the first machine learning system based on the layer-by-layer loss.
Aspect 2. The apparatus of Aspect 1, wherein the first machine learning system includes fewer self-attention layers in one or more upsampling layers of the first machine learning system compared to corresponding upsampling layers of the second machine learning system.
Aspect 3. The apparatus of any of Aspects 1 to 2, wherein the first machine learning system includes fewer cross-attention layers in one or more upsampling layers of the first machine learning system compared to corresponding upsampling layers of the second machine learning system.
Aspect 4. The apparatus of any of Aspects 1 to 3, wherein the training data includes a training image including noise and a mask.
Aspect 5. The apparatus of any of Aspects 1 to 4, wherein the mask indicates an area of the training image for the first machine learning system to edit.
Aspect 6. The apparatus of any of Aspects 1 to 5, wherein the edit includes addition of an object to the training image.
Aspect 7. The apparatus of any of Aspects 1 to 6, wherein the at least one processor is configured to: determine, based on a comparison of a first denoised representation of a first image to a second denoised representation of the first image generated by the second machine learning system and a third denoised representation of the first image generated by a third machine learning system, a distribution loss of the first machine learning system; and adjust parameters of the first machine learning system based on the distribution loss to provide an adjusted first machine learning system.
Aspect 8. The apparatus of any of Aspects 1 to 7, wherein the second machine learning system is trained using data associated with synthetic images.
Aspect 9. The apparatus of any of Aspects 1 to 8, wherein the third machine learning system is trained using data associated with real images.
Aspect 10. The apparatus of any of Aspects 1 to 9, wherein the at least one processor is configured to: generate, using the adjusted first machine learning system, a second image; process, using the second machine learning system and the third machine learning system, the second image to generate a first denoised representation of the second image and a second denoised representation of the second image; determine, based on a comparison of the first denoised representation of the second image and a second denoised representation of the second image, an additional loss associated with the second machine learning system; and process, using an adversarial network, the second image to determine a GAN loss associated with the adversarial network; adjust parameters of the second machine learning system based on the GAN loss and the additional loss to provide an adjusted second machine learning system.
Aspect 11. The apparatus of any of Aspects 1 to 10, wherein the first machine learning system and the second machine learning system include U-Net architecture.
Aspect 12. The apparatus of any of Aspects 1 to 11, wherein the first machine learning system is trained using on-device training.
Aspect 13. A method for machine learning system training distillation, the method comprising: processing, using a first machine learning system, training data to determine a first plurality of outputs, each output of the first plurality of outputs corresponding to a layer of the first machine learning system; determining, based on a comparison of the first plurality of outputs to a second plurality of outputs associated with a second machine learning system, a layer-by-layer loss associated with the first machine learning system; and adjusting parameters of one or more layers of the first machine learning system based on the layer-by-layer loss.
Aspect 14. The method of Aspect 13, wherein the first machine learning system includes fewer self-attention layers in one or more upsampling layers of the first machine learning system compared to corresponding upsampling layers of the second machine learning system.
Aspect 15. The method of any of Aspects 13 to 14, wherein the first machine learning system includes fewer cross-attention layers in one or more upsampling layers of the first machine learning system compared to corresponding upsampling layers of the second machine learning system.
Aspect 16. The method of any of Aspects 13 to 15, wherein the training data includes a training image including noise and a mask.
Aspect 17. The method of any of Aspects 13 to 16, wherein the mask indicates an area of the training image for the first machine learning system to edit.
Aspect 18. The method of any of Aspects 13 to 17, wherein the edit includes addition of an object to the training image.
Aspect 19. The method of any of Aspects 13 to 18, further comprising: determining, based on a comparison of a first denoised representation of a first image to a second denoised representation of the first image generated by the second machine learning system and a third denoised representation of the first image generated by a third machine learning system, a distribution loss of the first machine learning system; and adjusting parameters of the first machine learning system based on the distribution loss to provide an adjusted first machine learning system.
Aspect 20. The method of any of Aspects 13 to 19, wherein the second machine learning system is trained using data associated with synthetic images.
Aspect 21. The method of any of Aspects 13 to 20, wherein the third machine learning system is trained using data associated with real images.
Aspect 22. The method of any of Aspects 13 to 21, further comprising: generating, using the adjusted first machine learning system, a second image; processing, using the second machine learning system and the third machine learning system, the second image to generate a first denoised representation of the second image and a second denoised representation of the second image; determining, based on a comparison of the first denoised representation of the second image and a second denoised representation of the second image, an additional loss associated with the second machine learning system; and processing, using an adversarial network, the second image to determine a GAN loss associated with the adversarial network; adjusting parameters of the second machine learning system based on the GAN loss and the additional loss to provide an adjusted second machine learning system.
Aspect 23. The method of any of Aspects 13 to 22, wherein the first machine learning system and the second machine learning system include U-Net architecture.
Aspect 24. The method of any of Aspects 13 to 23, wherein the first machine learning system is trained using on-device training.
Aspect 25. A non-transitory computer-readable medium having stored thereon instructions that, when executed by at least one processor, cause the at least one processor to perform one or more of operations according to any of Aspects 13 to 24.
Aspect 26. An apparatus for machine learning system training distillation comprising one or more means for performing operations according to any of Aspects 13 to 24.

What is claimed:

1. An apparatus for machine learning system training distillation, the apparatus comprising:
at least one memory; and
at least one processor coupled to the at least one memory and configured to:
process, using a first machine learning system, training data to determine a first plurality of outputs, each output of the first plurality of outputs corresponding to a layer of the first machine learning system;
determine, based on a comparison of the first plurality of outputs to a second plurality of outputs associated with a second machine learning system, a layer-by-layer loss associated with the first machine learning system; and
adjust parameters of one or more layers of the first machine learning system based on the layer-by-layer loss.

2. The apparatus of claim 1, wherein the first machine learning system includes fewer self-attention layers in one or more upsampling layers of the first machine learning system compared to corresponding upsampling layers of the second machine learning system.

3. The apparatus of claim 1, wherein the first machine learning system includes fewer cross-attention layers in one or more upsampling layers of the first machine learning system compared to corresponding upsampling layers of the second machine learning system.

4. The apparatus of claim 1, wherein the training data includes a training image including noise and a mask.

5. The apparatus of claim 4, wherein the mask indicates an area of the training image for the first machine learning system to edit.

6. The apparatus of claim 5, wherein the edit includes addition of an object to the training image.

7. The apparatus of claim 1, wherein the at least one processor is configured to:
determine, based on a comparison of a first denoised representation of a first image to a second denoised representation of the first image generated by the second machine learning system and a third denoised representation of the first image generated by a third machine learning system, a distribution loss of the first machine learning system; and
adjust parameters of the first machine learning system based on the distribution loss to provide an adjusted first machine learning system.

8. The apparatus of claim 7, wherein the second machine learning system is trained using data associated with synthetic images.

9. The apparatus of claim 7, wherein the third machine learning system is trained using data associated with real images.

10. The apparatus of claim 9, wherein the at least one processor is configured to:
generate, using the adjusted first machine learning system, a second image;
process, using the second machine learning system and the third machine learning system, the second image to generate a first denoised representation of the second image and a second denoised representation of the second image;
determine, based on a comparison of the first denoised representation of the second image and a second denoised representation of the second image, an additional loss associated with the second machine learning system; and
process, using an adversarial network, the second image to determine a GAN loss associated with the adversarial network; adjust parameters of the second machine learning system based on the GAN loss and the additional loss to provide an adjusted second machine learning system.

11. The apparatus of claim 1, wherein the first machine learning system and the second machine learning system include U-Net architecture.

12. The apparatus of claim 10, wherein the first machine learning system is trained using on-device training.

13. A method for machine learning system training distillation, the method comprising:
processing, using a first machine learning system, training data to determine a first plurality of outputs, each output of the first plurality of outputs corresponding to a layer of the first machine learning system;
determining, based on a comparison of the first plurality of outputs to a second plurality of outputs associated with a second machine learning system, a layer-by-layer loss associated with the first machine learning system; and
adjusting parameters of one or more layers of the first machine learning system based on the layer-by-layer loss.

14. The method of claim 13, wherein the first machine learning system includes fewer self-attention layers in one or more upsampling layers of the first machine learning system compared to corresponding upsampling layers of the second machine learning system.

15. The method of claim 13, wherein the first machine learning system includes fewer cross-attention layers in one or more upsampling layers of the first machine learning system compared to corresponding upsampling layers of the second machine learning system.

16. The method of claim 13, wherein the training data includes a training image including noise and a mask.

17. The method of claim 16, wherein the mask indicates an area of the training image for the first machine learning system to edit.

18. The method of claim 17, wherein the edit includes addition of an object to the training image.

19. The method of claim 13, further comprising:
determining, based on a comparison of a first denoised representation of a first image to a second denoised representation of the first image generated by the second machine learning system and a third denoised representation of the first image generated by a third machine learning system, a distribution loss of the first machine learning system; and
adjusting parameters of the first machine learning system based on the distribution loss to provide an adjusted first machine learning system.

20. A non-transitory computer-readable medium having stored thereon instructions that, when executed by at least one processor, cause the at least one processor to:
process, using a first machine learning system, training data to determine a first plurality of outputs, each output of the first plurality of outputs corresponding to a layer of the first machine learning system;
determine, based on a comparison of the first plurality of outputs to a second plurality of outputs associated with a second machine learning system, a layer-by-layer loss associated with the first machine learning system; and
adjust parameters of one or more layers of the first machine learning system based on the layer-by-layer loss.
